(19) United States
(12) Patent Application Publication
(10) Pub. No.: US 2026/0357125 A1
(43) Pub. Date: Nov. 12, 2026

(54) FORMULATION AND METHOD

(71) Applicant: Independence Oilfield Chemicals LLC, The Woodlands, TX (US)

(72) Inventors: Abby Lane Olivares, Houston, TX (US); Jeffrey C. Dawson, Conroe, TX (US); Kurt Hoeman, Houston, TX (US)

(21) Appl. No.: 19/657,606

(22) Filed: Apr. 24, 2026

Related U.S. Application Data
(60) Provisional application No. 63/796,710, filed on Apr. 29, 2025.

(51) Int. Cl. C09K 8/60; C09K 8/64; C09K 8/68; C09K 8/80; E21B 43/26

(52) U.S. Cl. CPC C09K 8/604; C09K 8/602; C09K 8/64; C09K 8/68; C09K 8/80; E21B 43/26

(57) ABSTRACT

A base formulation, for example for use in a fracturing fluid, the base formulation including:
(i) at least one hydrocarbon solvent; and
(ii) at least one surfactant selected from a non-ionic surfactant, an amphoteric surfactant, an anionic surfactant and a cationic surfactant, and combinations thereof,

In which when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof.

### FIELD OF THE INVENTION

The present invention relates to formulations, for example for use in a fracturing fluid, and to fracturing fluids for subterranean formations. The present invention also relates to methods of preparing the formulations and fracturing fluids, and to a method of fracturing a subterranean formation.

### BACKGROUND

Hydraulic fracturing is a process needed to produce oil and gas from subterranean formations. In this process, a fracturing fluid is injected at a rate and pressure necessary to cause formation failure by inducing fractures or cracks in the formation. These cracks originate at the well-bore and radiate out into the formation. It is common practice to initiate entry into the reservoir with a small slug of acid pumped at low rates followed by injection of a low viscosity water pumped at increasing rate until the desired pump rate is achieved. High pump rates typically can range from 50 to 100 barrels per minute. In order to pump at these high rates, small amounts of friction reducers are added to the fluid. These friction reducers are normally polyacrylamide polymers and copolymers added at a treat rate typically around 100 to 1,000 ppm of the fracturing fluid. These low viscosity, friction reducer assisted fluids are referred to as slick-water and the process or treatment is referred to as slick-water fracturing.

Polymeric friction reducers can damage the formation and/or can form deposits downhole, which can reduce oil and gas production.

The hydraulic fracturing process also uses a proppant (also known as propping agent), such as small-sized sand. The proppant acts to keep a hydraulic fracture open during or following a fracturing treatment. Normally, in the last 30-40% of the sand volume, it is common practice to change the fracturing fluid from a low viscosity fluid to a high viscosity fluid so that higher concentrations of proppant can be placed in the fracture.

The amount of sand commonly used in the fracturing treatment will range from 200,000 lb to 800,000 lb per fracturing stage and the water can commonly range from 4,700 to 19,000 barrels of water. It is not uncommon for the number of fracturing treatments or stages to range from 30 to over 70 stages per well so that water requirements for all the fracturing treatments can range from 1.2 to 15 million gallons of water.

In slick-water fluids, placement of the proppant into the fractures is often poor, which necessitates the high quantities of both water and proppant used. Pipe perforations can cause the fluid velocity to fall and the size of fractures means it is hard to sustain the velocity required to transport proppant within the fracture, contributing to settling of the proppant in the wellbore and/or poor proppant placement in the fracture.

Thus, during the fracturing process it is necessary to improve the transport of proppant within the wellbore. It is desirable that this is done without using the large volumes of water commonly used in slick-water fracturing and preferably without the use of water-soluble polymers as friction reducers. It is also desirable to improve the placement of proppant within fractures, which leads to improvements in oil and gas production. It is also desirable to reduce the pump pressure and energy consumption associated with high pump rates.

It is therefore desirable to improve the transport and/or placement of proppant in a fracturing process, for example by minimising the volume of water in which the proppant is transported and/or without the use of water-soluble polymers as friction reducers.

### SUMMARY

According to a first aspect of the present invention there is provided a base formulation, for example for use in a fracturing fluid, the base formulation comprising:
(i) at least one hydrocarbon solvent; and
(ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof.

According to a second aspect of the present invention there is provided a base emulsion formulation, for example for use in a fracturing fluid, the base emulsion formulation comprising:
(i) at least one hydrocarbon solvent;
(ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof; and
(iii) at least one aqueous fluid, wherein the base emulsion formulation comprises up to 50 wt % of the aqueous fluid(s) based on the total weight of the base emulsion formulation.

According to a third aspect of the present invention, there is provided a fracturing fluid base formulation comprising:
(i) at least one hydrocarbon solvent;
(ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof; and
(iii) at least one aqueous fluid,
   wherein the fracturing fluid base formulation comprises from above 50 wt % to 99.5 wt % of the aqueous fluid(s) based on the total weight of the fracturing fluid base formulation.

According to a fourth aspect of the invention, there is provided a fracturing fluid comprising the fracturing fluid base formulation according to the third aspect and further comprising at least one proppant.

According to a fifth aspect of the present invention there is provided a method of preparing a base formulation according to the first aspect, the method comprising:
(a) selecting and admixing the hydrocarbon solvent(s) (i) and the surfactant(s) (ii).

According to a sixth aspect of the present invention there is provided a method of preparing a base emulsion formulation according to the second aspect, the method comprising:
(a) selecting and admixing the hydrocarbon solvent(s) (i), the surfactant(s) (ii) and the aqueous fluid(s) (iii).

According to a seventh aspect of the present invention there is provided a method of preparing a fracturing fluid base formulation according to the third aspect, the method comprising:
(a) selecting and admixing the hydrocarbon solvent(s) (i), the surfactant(s) (ii) and the aqueous fluid(s) (iii).

According to an eighth aspect of the present invention there is provided a base formulation made by the method of the fifth aspect.

According to a ninth aspect of the present invention there is provided a base emulsion formulation made by the method of the sixth aspect.

According to a tenth aspect of the present invention there is provided a fracturing fluid base formulation made by the method of the seventh aspect.

According to an eleventh aspect of the present invention there is provided a method of preparing a fracturing fluid according to the fourth aspect, the method comprising admixing the fracturing fluid base formulation according to the third or tenth aspect with at least one proppant.

According to a twelfth aspect of the present invention there is provided a fracturing fluid made by the method of the eleventh aspect.

According to a thirteenth aspect of the present invention there is provided a method of fracturing a subterranean formation, the method comprising contacting the formation with a fracturing fluid according to the fourth or twelfth aspect.

According to a fourteenth aspect of the present invention there is provided an assembly positioned adjacent a subterranean formation and arranged to deliver a fracturing fluid into the formation, said assembly comprising:
(I) a receptacle containing at least one aqueous fluid;
(II) a receptacle containing a base formulation according to the first or eighth aspect or a base emulsion formulation according to the second or ninth aspect;
(III) a receptacle containing at least one additive, for example at least one proppant;
(IV) at least one pump (PI) for dosing the base formulation or the base emulsion formulation from the receptacle (II) and the at least one additive from the receptacle (III) into the at least one aqueous fluid, suitably to provide at least part of a fracturing fluid;
(V) a conduit for delivering the fracturing fluid into the formation; and
(VI) a pump (P2) for injecting the fracturing fluid via the conduit into the formation.

According to a fifteenth aspect of the present invention, there is provided a use of a fracturing fluid according to the fourth or twelfth aspect for fracturing a subterranean formation.

### DETAILED DESCRIPTION

Unless otherwise stated, the following terms used in the specification and claims have the meanings set out below.

The terms “alkyl” and “alkenyl” include both straight and branched chain alkyl and alkenyl groups respectively.

As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

Unless otherwise mentioned all references to ppm in this specification are to parts per million by weight.

Unless otherwise stated herein, the reference to “liquid” and “solid” refer to a state at 25 °C and standard pressure (101,325 Pa).

References to the formulations and fracturing fluids etc comprising at least one of the components specified mean that they may comprise one or more than one (for example two or three) of the components specified. Thus, throughout the specification, all references to the various components may refer to one or more of those components being present. This is shown by reference to the various component(s) as either single (component) or plural (components) throughout.

According to a first aspect of the present invention there is provided a base formulation, for example for use in a fracturing fluid, the base formulation comprising:
(i) at least one hydrocarbon solvent; and
(ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof.

Preferably the base formulation of the first aspect is non-aqueous, by which we mean that it is substantially free or is free of water. By substantially free of water we mean that no water is added but some water may be present in the surfactant(s).

The base formulation of the first aspect may be used in a fracturing fluid, such as in a fracturing fluid according to the fourth or twelfth aspect. In other words, the base formulation is suitable for inclusion in a fracturing fluid, such as in a fracturing fluid according to the fourth or twelfth aspect.

The base formulation of the first aspect may be used to prepare the base emulsion formulation according to the second or ninth aspect, which base emulsion formulation may be used to prepare the fracturing fluid base formulation of the third or tenth aspect.

In particular, the base formulation of the first aspect may be used to prepare the base emulsion formulation according to the second aspect, which base emulsion formulation may be used to prepare the fracturing fluid base formulation of the third aspect, and which fracturing fluid base formulation may be used to prepare the fracturing fluid of the fourth aspect.

The base formulation of the first aspect comprises (i) at least one hydrocarbon solvent.

The hydrocarbon solvent is suitably a liquid solvent. The hydrocarbon solvent may be selected from at least one of paraffinic hydrocarbons, naphthenic hydrocarbons, aromatic hydrocarbons, benzene, xylene, toluene, mineral oils, diesel oil, kerosenes, naphthas (including hydrotreated naphtha), petrolatums, branch-chain isoparaffinic solvents, branch-chain hydrocarbons, saturated, linear, and/or branched paraffin hydrocarbons. The hydrocarbon solvent may include a natural, modified or synthetic oil; or a vegetable oil such as canola oil, coconut oil, rapeseed oil, hydrotreated vegetable oil (HVO) and the like.

The hydrocarbon solvent may be a refined oil. Suitable refined oils include hydro-treated naphtha, oligomers of ethylene, gas-to-liquid (GTL) oils, raffinate oils, kerosene, diesel, and heavy aromatic naphthas. Hydro-treated naphtha, oligomers of ethylene, gas-to-liquid (GTL) oils, or raffinate oils are preferred. Suitably, the refined oil is free or substantially free of BTEX (benzene, toluene, ethylbenzene and xylene). Suitably, the refined oil comprises BTEX in an amount of less than 10 ppm, such as less than 1 ppm, preferably less than 0.1 ppm.

Preferably the hydrocarbon solvent does not comprise a polyolefin that is a solid at room temperature and pressure.

The hydrocarbon solvent may be a crude oil, such as a crude oil having an API (American Petroleum Institute) gravity value of greater than 22.

The base formulation comprises at least one hydrocarbon solvent. For example, the base formulation may comprise one (i.e. a single) hydrocarbon solvent. Alternatively, the base formulation may comprise more than one, for example two or more, or three or more hydrocarbon solvents. For example, the base formulation may comprise a mixture of two or more suitable hydrocarbon solvents, such as a mixture of two or more of the suitable hydrocarbon solvents disclosed herein.

Preferably the base formulation comprises one (i.e. a single) hydrocarbon solvent. When the base formulation comprises one (i.e. a single) hydrocarbon solvent, that hydrocarbon solvent may be a refined oil, such as hydro-treated naphtha.

The base formulation of the first aspect may comprise any suitable amount of the hydrocarbon solvent(s) and the particular amount may, as would be appreciated by persons skilled in the art, depend on the particular base formulation or on the particular base emulsion formulation, fracturing fluid base formulation or fracturing fluid in which the base formulation is to be used.

For example, the base formulation of the first aspect may comprise up to 90 wt % of the hydrocarbon solvent(s) wherein the wt % is based on the total weight of the base formulation.

For example, the base formulation of the first aspect may comprise at least 50 wt %, for example at least 60 or 65 wt %, of the hydrocarbon solvent(s) wherein the wt % is based on the total weight of the base formulation.

For example, the base formulation of the first aspect may comprise from 50 to 90 wt %, for example from 60 to 90 or from 65 to 90 wt %, of the hydrocarbon solvent(s) wherein the wt % is based on the total weight of the base formulation.

References herein to the base formulation comprising an amount (as defined herein) of the hydrocarbon solvent(s) relate to the total amount of the hydrocarbon solvent(s) present, such that if the base formulation comprises more than one hydrocarbon solvent the amount relates to the combined total of the hydrocarbon solvents present (i.e. based on the total weight of the base formulation). The same applies to all other amounts as defined herein unless otherwise stated.

The base formulation of the first aspect comprises (ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof.

References herein to non-ionic surfactants are intended to refer to the list of non-ionic surfactants as defined in relation to component (ii) herein, unless otherwise stated.

The base formulation of the first aspect may comprise any combination of non-ionic, amphoteric, anionic and cationic surfactant(s) as defined herein, including combinations thereof. For example, the base formulation may comprise at least one non-ionic surfactant and at least one amphoteric surfactant, or at least one non-ionic surfactant, at least one amphoteric surfactant and at least one anionic surfactant, and so on.

Preferably, the base formulation of the first aspect comprises at least one non-ionic surfactant as defined herein.

The or each non-ionic surfactant may be a non-ionic emulsifier.

When the base formulation comprises at least one non-ionic surfactant, the non-ionic surfactant(s) is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol (including mixtures thereof).

Suitable fatty alcohol compounds include, for example, C8-24 fatty alcohols. Suitable fatty alcohol compounds include C8-24 fatty alcohols, which may comprise a mixture of C8-24 fatty alcohols. For example, a suitable fatty alcohol compound is a C16-18 fatty alcohol such as cetearyl alcohol.

Suitable fatty alcohol alkoxylate compounds include, for example, C8-24, such as C9-15, for example C14-15, fatty alcohol alkoxylates. In other words, the fatty alcohol alkoxylate compounds may be derived from fatty alcohols comprising from 8 to 24, such as from 9 to 15, for example 14 or 15, carbon atoms, typically a mixture of such fatty alcohols. The fatty alcohol alkoxylate compounds may be derived from any suitable fatty alcohol, for example from stearyl alcohol, cocoyl alcohol, or from alcohol derived from soy or tallow. The fatty alcohols may be alkoxylated with ethylene oxide and/or propylene oxide, i.e. to provide ethoxylated and/or propylated compounds. Typically, the fatty alcohols are ethoxylated. For example, the fatty alcohol alkoxylate compounds may be derived from fatty alcohols comprising 8-18 carbon atoms and may be alkoxylated with 5 to 20 moles of alkylene oxide (for example ethylene oxide). Examples of suitable fatty alcohol alkoxylate compounds include ethoxylated (5-8 mols of EO) C8-13 fatty alcohol, ethoxylated (12 mols of EO) C12-15 fatty alcohol, ethoxylated (5-7 mols of EO) C9-11 fatty alcohol, C14-15 pareth-13, ceteareth-20 (C14-16); oleth-5 and PPG-5-ceteth-20. These compounds are commercially available, for example under the Tomadol® tradename.

Fatty acid alkanolamide compounds are suitably a reaction product of a fatty acid and an alkanolamide. Suitable fatty acids include caprylic acid, capric acid, lauric acid, myristic acid, palmitic acid, stearic acid, arachidic acid, behenic acid, lignoceric acid, cerotic acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, undecylenic acid and docosahexanoic acid. Preferred fatty acids include linoleic acid and oleic acid. Mixtures of fatty acids may also be used, for example coconut oil fatty acid, rapeseed oil fatty acid, or tall oil fatty acid. Tall oil fatty acid comprises a mixture of predominantly unsaturated fatty acids having mostly 18 carbon atoms. Typically tall oil fatty acids comprise mainly oleic acid and linoleic acids. The skilled person will appreciate that fatty acids derived from natural sources typically comprise mixtures of compounds. Suitable alkanolamines include diethanolamine, ethanol amine, propanolamine, dipropanolamine, isopropanolamine, di(isopropanol)amine and 2-(2-aminoethylamino) ethanol.

Preferred fatty acid alkanolamide compounds include, for example, C8-C24 fatty acid alkanolamides, such as cocodiethanolamide, cocomonoethanolamide, rapeseed oil diethanolamide, tall oil diethanolamide and oleic acid diethanolamide. A more preferred example of a fatty acid alkanolamide compound is tall oil fatty acid diethanolamide.

Suitable fatty acid amide alkoxylates include, for example, cocamide, tallowamide, hydrogenated tallowamide, lauramide or oleamide reacted with 2 to 50 moles of ethylene oxide or propylene oxide.

Suitable hydroxy fatty acid alkoxylate compounds include, for example, castor oil alkoxylates (such as ethoxylates and/or propoxylates).

Suitable hydroxy fatty acid amide alkoxylate compounds include, for example, ethoxylated (EO50) hydrogenated palmalkylamide and ethoxylated (EO13) hydrogenated tallow alkylamide. Suitable triglyceride alkoxylate compounds include triglyceride ethoxylates (EO12-54) and hydrogenated PEG-50 castor oil.

A suitable tristyryl phenol alkoxylate is, for example, an EO14-54 tristyryl phenol alkoxylate or an EO60 tristyryl phenol alkoxylate. These compounds are commercially available such as for example Makon 60.

Fatty acid esters of alkoxylated sorbitan are suitably a reaction product of sorbitan, an alkylene oxide, and (subsequently) a fatty acid. Suitably, the average number of moles of alkylene oxide per mole of sorbitan is from 1 to 40, such as from 3 to 40 or from 10 to 30, for example from 15 to 25 or from 5 to 20. Preferably, the average number of moles of alkylene oxide per mole of sorbitan is 20. Suitable alkylene oxides include ethylene oxide, propylene oxide, butylene oxide or mixtures thereof. Preferably, the alkylene oxide is ethylene oxide. Suitably, the average molar ratio of the fatty acid to the alkoxylated sorbitan is 1:1. Suitable fatty acids include C8-22 fatty acids, preferably oleic acid.

Suitable fatty acid esters of alkoxylated sorbitan include fatty acid esters of ethoxylated sorbitan, for example a fatty acid ester of ethoxylated (EO20) sorbitan. These compounds are also known commercially as Tweens. Preferred such compounds include, for example, a mono ester of ethoxylated sorbitan with at least one of lauric acid, palmitic acid, oleic acid and stearic acid. Especially preferred is ethoxylated (EO20) sorbitan monooleate sold commercially under the tradenames Tween 80 or Polysorbate 80. Also especially preferred is ethoxylated (EO5) sorbitan monooleate sold commercially as Tween 81.

Suitable polyalkylene alkoxylate compounds include polyethylene oxide, polypropylene oxide, and block copolymers of poly(ethylene oxide) and poly(propylene oxide).

Suitable glycerol alkoxylate compounds include glycerol reacted with 1 to 30, preferably 5 to 15 moles of ethylene oxide (EO), for example glycereth-7 or glycereth-8.

Suitable fatty acid alkoxylate compounds include, for example, fatty acid ethoxylate compounds. The fatty acid alkoxylate (or ethoxylate) compounds may be prepared from any suitable fatty acids. Suitable fatty acids may comprise from 8 to 22 carbon atoms and may be synthetic or natural. Examples of suitable natural fatty acids include those derived from soy, palm, canola, rapeseed and coconut.

Suitable alkoxylated alkylphenol compounds include ethoxylated alkylphenol compounds, such as for example EO6-50 nonylphenol.

Suitable polyalkylene glycol ether compounds include polyethylene glycol ether compounds, for example poly(ethylene oxide) or poly(ethylene oxide)-poly(propylene oxide).

Suitable polyalkoxylated tallow amine compounds include polyethoxylated tallow amine compounds, such as N-tallow-poly (3) oxyethylene-1,3-diaminopropane.

Suitable fatty acid esters of sorbitan include, for example, monostearate esters, tristearate esters and monolaurate esters. These compounds are also known commercially as Spans. Preferred fatty acid esters of sorbitan include sorbitan olivate and sorbitan oleates, especially sorbitan monooleate sold commercially under the tradename Span 80.

Suitable fatty acid ester compounds include, for example, polyglycerol-2 sesquiisostearate, polyglycerol-2 distearate, PEG-4 polyglycerol-2 stearate, glyceryl stearate and sodium stearoyl lactylate.

Suitable sugar ester compounds include, for example, sucrose polystearate and sunflower seed oil sorbitol esters.

Suitable alkyl polyglucoside compounds include, for example, C10-16 alkyl polyglucoside compounds, such as lauryl glucoside.

Suitable esters of polyglycerol include reaction products of polyglycerol and a hydroxycarboxylic acid or a polymer of the hydroxycarboxylic acid. The polyglycerol may have a number average molecular weight of from 180 to 1840, for example from 180 to 368. In some embodiments, the reaction product is obtained by polymerising the hydroxycarboxylic acid in the presence of the polyglycerol. Preferably, the hydroxycarboxylic acid is polymerised separately to form a poly(hydroxycarboxylic acid) and then reacted with the polyglycerol. The hydroxycarboxylic acid may comprise from 8 to 22 carbon atoms. The hydroxycarboxylic acid may be selected from glycolic acid, lactic acid, hydroxybutyric acid, hydroxyvaleric acid, hydroxycaproic acid, hydroxystearic acid (preferably 12-hydroxystearic acid), 2,2-bis(hydroxymethyl)propionic acid, hydroxyarachidic acid, mandelic acid, ricinoleic acid, and isoricinoleic acid. Preferably, the hydroxycarboxylic acid is ricinoleic acid. Further preferably, the ester of polyglycerol is the reaction product of polyglycerol and poly(ricinoleic acid) (PGPR), such as polyglycerol-2 polyricinoleate and polyglycerol-3 polyricinoleate. Such products are sold commercially a Sebumul PGPR. Polyglycerol may alternatively be referred to as polyglyceryl.

Suitable non-ionic surfactants may be selected from at least one of a fatty acid alkanolamide (such as a C8-24 fatty acid alkanolamide), a fatty acid ester of sorbitan, a fatty acid ester of alkoxylated sorbitan, and an ester of polyglycerol.

Examples of preferred non-ionic surfactants include a fatty alcohol alkoxylate (such as a C8-24 fatty alcohol alkoxylate), a fatty acid alkanolamide, a hydroxy fatty acid alkoxylate, a triglyceride alkoxylate, a tristyryl phenol alkoxylate, a fatty acid ester of alkoxylated (such as ethoxylated) sorbitan, a polyalkylene alkoxylate, a glycerol alkoxylate, a fatty acid alkoxylate (such as ethoxylate), an alkoxylated alkyl phenol, a polyalkylene glycol ether (such as a polyethylene glycol ether) and a polyalkoxylated (such as polyethoxylated) tallow amine (including mixtures thereof).

Examples of preferred non-ionic surfactants may include at least one of a fatty alcohol alkoxylate (such as a C8-24 fatty alcohol alkoxylate), a fatty acid alkanolamide, a hydroxy fatty acid alkoxylate, a triglyceride alkoxylate, a tristyryl phenol alkoxylate, a fatty acid ester of alkoxylated (for example ethoxylated) sorbitan, a fatty acid ester of sorbitan, a polyalkylene alkoxylate, a glycerol alkoxylate, a fatty acid alkoxylate (such as ethoxylate), a fatty acid ester, a sugar ester, an alkyl polyglucoside (such as a C10-16 alkyl polyglucoside), an alkoxylated alkyl phenol, a polyalkylene glycol ether (such as a polyethylene glycol ether), a polyalkoxylated (such as polyethoxylated) tallow amine, and an ester of polyglycerol.

More preferred non-ionic surfactants include esters of polyglycerol such as the reaction product of polyglycerol and poly(ricinoleic acid) (PGPR), polyglycerol-2 polyricinoleate, polyglycerol-3 polyricinoleate.

More preferred non-ionic surfactants include fatty acid alkanolamide compounds, such as tall oil fatty acid diethanolamide.

More preferred non-ionic surfactants include fatty acid esters of sorbitan, such as sorbitan olivate and sorbitan oleates, especially sorbitan monooleate sold commercially under the tradename Span 80.

More preferred non-ionic surfactants include fatty acid esters of alkoxylated sorbitan, such as fatty acid esters of ethoxylated sorbitan, for example a fatty acid ester of ethoxylated (EO20) sorbitan. These compounds are also known commercially as Tweens. Preferred such compounds include, for example, ethoxylated (EO20) sorbitan monooleate sold commercially under the tradename Tween 80 and ethoxylated (EO5) sorbitan monooleate sold commercially as Tween 81.

More preferred non-ionic surfactants include esters of polyglycerol (such as the reaction product of polyglycerol and poly(ricinoleic acid) (PGPR), polyglycerol-2 polyricinoleate, polyglycerol-3 polyricinoleate), fatty acid alkanolamide compounds (such as tall oil fatty acid diethanolamide), fatty acid esters of sorbitan (such as sorbitan olivate and sorbitan oleates, especially sorbitan monooleate sold commercially under the tradename Span 80), and fatty acid esters of alkoxylated sorbitan (such as fatty acid esters of ethoxylated sorbitan, for example a fatty acid ester of ethoxylated (EO20) sorbitan such as ethoxylated (EO20) sorbitan monooleate sold commercially under the tradename Tween 80 and ethoxylated (EO5) sorbitan monooleate sold commercially as Tween 81).

Suitably, the or each non-ionic surfactant has a hydrophobic-lipophilic balance (HLB) value of from 7 to 10, such as from 7 to 9, for example from 7 to 8. When there is more than one non-ionic surfactant, the weight averaged HLB value of the non-ionic surfactants is suitably from 7 to 10, such as from 7 to 9, for example from 7 to 8.5.

Suitably, the at least one surfactant (ii) comprises at least one non-ionic surfactant, preferably wherein the or each non-ionic surfactant has a hydrophobic-lipophilic balance (HLB) value of from 7 to 10.

The term “HLB value” would be well understood by a person skilled in the art to mean a measure of the degree of hydrophilicity or lipophilicity of the non-ionic surfactant.

As the skilled person would appreciate, HLB values can either be calculated or experimentally determined. Experimental methods to determine HLB values include using comparative testing by forming a series of emulsions with a surfactant and an oil of known HLB value.

Preferably, the base formulation of the first aspect comprises at least one amphoteric surfactant.

The or each amphoteric surfactant may be an amphoteric emulsifier.

Any suitable amphoteric surfactant(s), especially amphoteric emulsifier(s), may be included in the base formulation. Suitable amphoteric surfactant(s), especially amphoteric emulsifier(s), would be known to persons skilled in the art.

Examples of suitable amphoteric surfactants include at least one of a betaine, a sultaine, an amine oxide and a phosphatidylcholine.

Suitable betaine compounds include, for example, a C8-18 alkylamido propyl betaine, suitably lauryl amidopropyl betaine and/or cocamidopropyl betaine.

Suitable sultaine compounds include, for example, a C8-18 alkylamido hydroxyalkyl sultaine, suitably cocamidopropyl hydroxysultaine.

Suitable amine oxide compounds include, for example, lauryldimethylamine oxide.

Suitable phosphatidylcholine compounds include, for example, dipalmitoylphosphatidylcholine. The amphoteric surfactant may comprise a source of a phosphatidylcholine compound, such as lecithin. Lecithin may be obtained by extraction from a suitable source such as egg yolk, sunflower oil, soybean, milk, rapeseed, cotton seed and peanuts. For example, lecithin derived from soybean may be known as soy lecithin.

Preferred amphoteric surfactants may be phosphatidylcholine compounds, such as lecithin derived from soybean.

Preferably, the base formulation of the first aspect comprises at least one anionic surfactant.

The or each anionic surfactant may be an anionic emulsifier.

Any suitable anionic surfactant(s), especially anionic emulsifier(s), may be included in the base formulation. Suitable anionic surfactant(s), especially anionic emulsifier(s), would be known to persons skilled in the art.

Examples of suitable anionic surfactants may include at least one of a sulfonate compound, a sulfate compound, a sulfosuccinate ester, a phosphate compound, a fatty alcohol ether carboxylic acid, an isethionate, a taurate, or a salt or a derivative of any of the aforementioned, or an N-acyl amino acid.

Examples of suitable sulfonate compounds include alkylbenzene sulfonate compounds and α-olefin sulfonate compounds.

Suitable alkylbenzene sulfonate compounds may comprise linear or branched alkyl groups having from 8 to 14 carbon atoms. For example, a suitable alkylbenzene sulfonate compound may be dodecylbenzenesulfonate (DDBS), or a salt or a derivative thereof. Examples of suitable salts include alkanolamine, isopropylamine and calcium salts.

Suitable α-olefin sulfonate compounds include C12-22, for example C14-16, α-olefin sulfonate compounds, and salts and derivatives thereof. Preferred α-olefin sulfonate compounds include sodium C14-16 α-olefin sulfonates such as those sold under the Nansa® name.

Examples of suitable sulfate compounds include ether sulfate compounds.

Suitable ether sulfate compounds include, for example, sodium lauryl sulfate (SLS) and sodium lauryl ether sulfate (SLES), and salts and derivatives thereof.

Examples of suitable sulfosuccinate compounds include, for example, for example a dialkyl sulfosuccinate (such as a dioctyl sulfosuccinate), alkyl ether sulfosuccinates (such as laureth sulfosuccinates) and amidosulfosuccinates (such as oleamido MIPA sulfosuccinate), and salts (preferably sodium) and derivatives thereof.

Examples of suitable phosphate compounds include, for example, fatty alcohol ethoxylated phosphate compounds and phosphate esters of an ethoxylated alkylphenol. Suitable fatty alcohol ethoxylated phosphate compounds include a phosphate of a EO3-30 C8-22 alcohol, preferably, oleth-3 phosphate, trilaureth-4 phosphate or triceteareth-4 phosphate. Suitable phosphate esters of an ethoxylated alkylphenol include, for example phenol EO3 phosphate, nonylphenol EO6-10 phosphate and salts thereof, suitably sodium salts thereof.

Suitable N-acyl amino acids include the reaction product of a fatty acid or reactive equivalent thereof and an amino acid such as, for example, alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine and valine.

Examples of suitable fatty alcohol ether carboxylic acids include, for example, a C8-22 fatty alcohol reacted with alkylene oxide and then monochloroacetic acid (as a carboxylating agent). Suitable examples include trideceth-7 carboxylic acid, laureth-5 carboxylic acid, laureth-7 carboxylic acid and salts thereof.

Suitable taurate surfactants may each be of the formula (I):

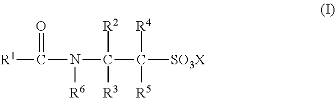

wherein X is hydrogen, a metal ion or an optionally substituted ammonium ion; R¹ represents an optionally substituted C₃-C₃₅ hydrocarbyl group; and each of R², R³, R⁴, R⁵ and R⁶ independently represents hydrogen or a C₁-C₄ alkyl group.

Suitably R¹ represents an optionally substituted C₃-C₃₅ alkyl, C₃-C₃₅ alkenyl, C₆-C₁₂ aryl, C₆-C₁₂ aryl-C₈-C₂₂ alkyl or C₈-C₂₂ alkyl-C₆-C₁₂ aryl group.

Suitably R¹ represents an optionally substituted C₃-C₃₅ alkyl, C₃-C₃₅ alkenyl, C₆-C₁₂ aryl or C₈-C₂₂ alkyl-C₆-C₁₂ aryl group. More suitably, R¹ represents an optionally substituted C₃-C₃₅ alkyl or C₃-C₃₅ alkenyl group, especially an optionally substituted C₃-C₃₅ alkenyl group. Most suitably, R¹ represents a C₃-C₃₅ alkyl or C₃-C₃₅ alkenyl group, especially a C₃-C₃₅ alkenyl group.

Suitably R¹ represents a mixture of optionally substituted C₃-C₃₅ alkyl, C₃-C₃₅ alkenyl, C₆-C₁₂ aryl, C₆-C₁₂ aryl-C₈-C₂₂ alkyl or C₈-C₂₂ alkyl-C₆-C₁₂ aryl groups having differing chain lengths. For example R¹ may be derived from the mixture of fatty acids having differing chain lengths found in triglyceride oils for example coconut oil, palm oil, palm kernel oil, olive oil, vegetable oil, sunflower oil or rapeseed oil.

Suitably R¹ may represent an optionally substituted C₃-C₃₅ alkyl or C₃-C₃₅ alkenyl group, such as an optionally substituted C₈-C₂₄ alkyl or C₈-C₂₄ alkenyl group, or an optionally substituted C₁₂-C₁₈ alkyl or C₁₂-C₁₈ alkenyl group.

Suitably R¹ may represent a C₃-C₃₅ alkyl or C₃-C₃₅ alkenyl group, such as a C₈-C₂₄ alkyl or C₈-C₂₄ alkenyl group, or a C₁₂-C₁₈ alkyl or C₁₂-C₁₈ alkenyl group.

Suitably R¹ may represent an optionally substituted C₄-C₂₉ alkyl group, such as an optionally substituted C₇-C₂₃ alkyl group, for example an optionally substituted C₁₁-C₂₃ alkyl group, preferably an optionally substituted C₁₃-C₂₁ alkyl group.

Examples of suitable substituents for the group R¹ may include C1-4 alkoxy, cyano, hydroxy, oxo and halo (especially fluoro and chloro).

R¹ is suitably provided by one or more fatty acids (i.e. one or more acids of formula R¹COOH). Fatty acids obtained from natural oils often include mixtures of fatty acids. For example, the fatty acid obtained from coconut oil contains a mixture of fatty acids including C₁₂ lauric acid, C₁₄ myristic acid, C₁₆ palmitic acid, C₈ caprylic acid, C₁₀ capric acid and C₁₈ stearic and oleic acid. R¹ may be provided by one or more naturally occurring fatty acids and/or of one or more synthetic fatty acids. For example, R¹ may consist essentially of or consist of the residue of a single fatty acid.

R¹ may be provided by one or more naturally occurring and/or renewable fatty acids.

Examples of carboxylic acids from which R¹ may be derived include coco acid, hexanoic acid, caproic acid, caprylic acid, capric acid, lauric acid, myristic acid, palmitic acid, palmitoleic acid, stearic acid, oleic acid, linoleic acid, arachidic acid, gadoleic acid, arachidonic acid, eicosapentanoic acid, behenic acid, erucic acid, docosahexanoic lignoceric acid, naturally occurring fatty acids such as those obtained from coconut oil, tallow, palm kernel oil, butterfat, palm oil, olive oil, corn oil, linseed oil, peanut oil, fish oil and rapeseed oil; synthetic fatty acids made as chains of a single length or a selected distribution of chain lengths; and mixtures thereof. R¹ may also be derived from fatty acids obtained via fermentation or general biotechnological processes, or from waste vegetable oils. These may be obtained by chemical or enzymatic routes.

Suitably R¹ may be provided by oleic acid, mixed fatty acids derived from coconut oil or the mixed fatty acids derived from palm kernel oil. Suitable coconut derived feedstocks include coconut fatty acid, coconut oil, coconut oil methyl esters, virgin coconut oil, refined bleached and deodorised coconut oil, ‘distilled and topped’ hardened coconut fatty acid and methyl esters thereof. Also useful are palm oil, hydrogenated palm kernel oil derived C₁₂-C₁₈ fatty acids (hardened and topped fatty acid) and methyl esters thereof.

Preferably, R¹ predominantly comprises the residue of an unsaturated fatty acid having 18 carbon atoms.

R¹ may be derived from the mixture of fatty acids having differing chain lengths found in rapeseed oil.

In the formula (I), each of R², R³, R⁴, R⁵ and R⁶ is independently selected from hydrogen or a C₁ to C₄ alkyl group. When any of R², R³, R⁴, R⁵ and R⁶ is a C₁ to C₄ alkyl group, the alkyl group is suitably n-propyl, ethyl or methyl, such as ethyl or methyl, most preferably methyl.

Suitably each of R², R³, R⁴, R⁵ and R⁶ may be hydrogen, i.e. the compound of formula (I) may be an acyl taurate surfactant.

Suitably, R⁶ may be a C₁ to C₄ alkyl group, each of R², R³, R⁴ and R⁵ may be hydrogen and the compound of formula (I) may be an acyl N-alkyl taurate surfactant. Where the compound of formula (I) is an acyl N-alkyl taurate surfactant, R⁶ may preferably be n-propyl, ethyl or methyl. Preferably R⁶ may be ethyl or methyl, most preferably methyl. Thus the compound of formula (I) may preferably be an acyl N-methyl taurate surfactant.

Suitably, R⁶ may be a C₁ to C₄ alkyl group and each of R², R³, R⁴ and R⁵ may independently represent hydrogen or a C₁-C₄ alkyl group wherein at least one of R², R³, R⁴ and R⁵ is not hydrogen.

When at least one of R², R³, R⁴ and R⁵ represents a C₁-C₄ alkyl group, the alkyl group is suitably n-propyl, ethyl or methyl, such as ethyl or methyl, most preferably methyl. Suitably such surfactants comprise the reaction product of N-methyl methyl taurine and one or more fatty acids, that is a compound of formula R¹CONR⁶CHR²CHR⁴SO₃X in which one of R² and R⁴ is methyl and the other is hydrogen. Mixtures of these isomers may be present.

Suitably X represents hydrogen, a metal cation or an optionally substituted ammonium cation, preferably a metal cation. By “optionally substituted ammonium cation”, we mean to refer to an ammonium cation wherein the nitrogen atom may be substituted with from 1 to 4 optionally substituted hydrocarbyl groups. Suitable ammonium cations include those derived from alkyl amines and alkanolamines. Preferred ammonium cations include isopropanolamine, isopropylamine, ethanolamine, diethanolamine, triethanolamine and 2-amino-2-methyl-1,3-propanediol (AMPD). Preferred ammonium cations include NH₄⁺ and the ammonium cation of triethanolamine.

Suitable metal cations include alkali metal cations, for example sodium, lithium and potassium cations, and alkaline earth metal cations, for example calcium and magnesium cations. Suitably, X represents hydrogen, an alkali metal cation or an optionally substituted ammonium cation. Preferably, X represents a potassium or sodium cation. Most preferably, X represents a sodium cation.

The skilled person will appreciate that when X is a divalent metal cation two moles of anion will be present for each mole of cation.

Preferred taurate surfactants of formula (I) may be selected from sodium lauroyl taurate, sodium cocoyl taurate, sodium oleoyl taurate, sodium myristoyl taurate, sodium N-methyl lauroyl taurate, sodium N-methyl cocoyl taurate, sodium N-methyl oleoyl taurate, sodium N-methyl myristoyl taurate, sodium N-methyl methyl lauroyl taurate, sodium N-methyl methyl cocoyl taurate, sodium N-methyl methyl oleoyl taurate and sodium N-methyl methyl myristoyl taurate. Sodium N-methyl oleoyl taurate, sodium N-methyl cocoyl taurate, sodium N-methyl lauroyl taurate and sodium N-methyl methyl oleoyl taurate are especially preferred. Most preferred is sodium N-methyl cocoyl taurate.

Suitable isethionate surfactants include acyl isethionate surfactants, such as acyl alkyl isethionate surfactants. Suitable acyl isethionate surfactants may each be compounds of formula R⁷COOCHR⁸CHR⁹SO₃⁻M⁺ wherein R⁷ represents an optionally substituted C₄-C₃₆ hydrocarbyl group; R⁸ and R⁹ each independently represent hydrogen or a C₁-C₄ alkyl group and M⁺ represents a cation (such as an alkali metal cation, for example sodium, or an ammonium cation). Preferred acyl isethionate surfactants include sodium cocoyl isethionate, sodium lauroyl isethionate, sodium cocoyl methyl isethionate and sodium lauroyl methyl isethionate (and combinations thereof).

Preferred isethionate surfactants may include acyl alkyl isethionate surfactants of formula R⁷COOCHR⁸CHR⁹SO₃-M⁺ wherein R⁷ represents an optionally substituted C₄-C₃₆ hydrocarbyl group; one of R⁸ and R⁹ represents hydrogen and the other of R⁸ and R⁹ represents a C₁-C₄ alkyl group and M⁺ represents a cation (such as an alkali metal cation, for example sodium, or an ammonium cation).

Examples of suitable substituents for the group R⁷ may include C1-4 alkoxy, cyano, hydroxy, oxo and halo (especially fluoro and chloro).

Preferred isethionate surfactants may comprise a mixture of isomers in which the molar ratio of the compounds in which R⁸ is C1-C4 alkyl and R⁹ is hydrogen to compounds in which R⁸ is hydrogen and R⁹ is C₁-C₄ alkyl is from 99:1 to 1:99, from 99:1 to 1:1, from 98:2 to 2:1, or from 95:5 to 3:1. Suitably such mixtures comprise approximately 90 mol % of compounds in which R⁸ is C₁-C₄ alkyl and R⁹ is hydrogen and approximately 10 mol % of compounds in which R⁸ is hydrogen and R⁹ is C1-C4 alkyl.

Preferred acyl alkyl isethionate surfactants include sodium cocoyl methyl isethionate and sodium lauroyl methyl isethionate (and combinations thereof).

Preferred anionic surfactants, especially anionic emulsifiers, include, for example, an alkylbenzene sulfonate compound, an α-olefin sulfonate compound, an ether sulfate compound, a sulfosuccinate ester, a phosphate compound, an acyl isethionate, an acyl alkyl isethionate, an acyl N-alkyl taurate, an acyl taurate, or a salt or a derivative of any of the aforementioned, or an N-acyl amino acid. Most preferred anionic surfactants include taurates, for example acyl N-alkyl taurates.

Preferably, the base formulation of the first aspect comprises at least one cationic surfactant.

The or each cationic surfactant may be a cationic emulsifier.

Any suitable cationic surfactant(s), especially cationic emulsifiers, may be included in the base formulation. Suitable cationic surfactant(s), especially cationic emulsifier(s), would be known to persons skilled in the art.

Examples of suitable cationic surfactants may include at least one quaternary ammonium compound, commonly referred to as an ammonium compound (including di-quaternary ammonium compounds).

Suitable ammonium compounds may be prepared from a fatty alkyl amine, for example wherein the alkyl group may contain from 8 to 36, for example from 8 to 24, carbon atoms.

Suitable ammonium compounds may include, for example, alkyl trimethyl ammonium compounds, dialkyl dimethyl ammonium compounds, trialkyl methyl ammonium compounds, benzyl alkyl dimethyl ammonium compounds and benzyl dialkyl methyl ammonium compounds. Suitable counteranions for the ammonium compounds include, for example, halide (preferably chloride), salicylate and sulfate.

Suitable alkyl trimethyl ammonium compounds include those wherein the alkyl group is selected from dodecyl, hexadecyl, octadecyl, cocoyl, soy alkyl, tallow alkyl, 2-ethylhexyl and hydrogenated tallow, and mixtures thereof. Suitable alkyl trimethyl ammonium compounds include, for example, dodecyl trimethyl ammonium compound, hexadecyl trimethyl ammonium compound, octadecyl trimethyl ammonium compound, cocoyl trimethyl ammonium compound, soy alkyl trimethyl ammonium compound, tallow alkyl trimethyl ammonium compound, 2-ethylhexyl trimethyl ammonium compound, and hydrogenated tallow trimethyl ammonium compound.

Suitable dialkyl dimethyl ammonium compounds include those wherein the alkyl group is selected from cocoyl, hydrogenated tallow and 2-ethyl hexyl, and mixtures thereof. For example, the alkyl groups may be a mixture of two different alkyl groups, such as 2-ethyl hexyl and hydrogenated tallow.

Suitable trialkyl methyl ammonium compounds include those wherein the alkyl group is hexadecyl. For example a suitable trialkyl methyl ammonium compound is a tri(hexadecyl) methyl ammonium compound such as tri(hexadecyl) methyl ammonium chloride.

Suitable benzyl alkyl dimethyl ammonium compounds include those wherein the alkyl group is selected from cocoyl and hydrogenated tallow, and mixtures thereof. Preferred benzyl alkyl dimethyl ammonium compounds are benzyl alkyl dimethyl ammonium chloride compounds.

Suitable benzyl dialkyl methyl ammonium compounds include those wherein the alkyl group is hydrogenated tallow and/or wherein the counteranion is chloride.

Suitable ammonium compounds include di-quaternary ammonium compounds, for example N,N,N′,N′,N′-pentamethyl-N-tallow-1,3-propanediammoniumdichloride (available commercially as Duoquad T-50 E).

Suitable ammonium compounds include quaternised ethoxylated fatty amine compounds. Suitable quaternised ethoxylated fatty amine compounds include those derived from a fatty amine comprising an alkyl group selected from octadecyl, oleyl, cocoyl and tallow, and mixtures thereof. The fatty amine compounds may be alkoxylated with ethylene oxide and/or propylene oxide, i.e. to provide ethoxylated and/or propylated compounds. Typically, the fatty amines are ethoxylated, for example with 2 to 15 moles of ethylene oxide. Suitable quaternising agents include methyl chloride, methyl nitrate and methyl acetate.

The base formulation may comprise at least one or more than one surfactant. For example, the base formulation may comprise one (i.e. a single) surfactant. Alternatively, the base formulation may comprise more than one, for example two or more, or three or more, surfactants.

Preferably the base formulation comprises two or more, such as two or three, surfactants.

When the base formulation comprises more than one surfactant, this may be any combination of non-ionic, amphoteric, anionic and cationic surfactants as defined herein, including combinations thereof. The combinations may include more than one different non-ionic surfactant etc. Thus, any suitable combination of surfactants may be included.

Preferably the base formulation comprises at least one non-ionic surfactant. Preferably the only surfactant(s) present in the base formulation are non-ionic surfactants.

Preferably the base formulation comprises at least one non-ionic surfactant and/or at least one amphoteric surfactant. Preferably the only surfactant(s) present in the base formulation are non-ionic and/or amphoteric surfactants.

Preferably the base formulation comprises at least one non-ionic surfactant and at least one amphoteric surfactant. Preferably the only surfactant(s) present in the base formulation are non-ionic and amphoteric surfactants.

Preferably the base formulation comprises at least one non-ionic surfactant and/or at least one amphoteric surfactant and/or at least one anionic surfactant. Preferably the only surfactant(s) present in the base formulation are non-ionic and/or amphoteric surfactants and/or anionic surfactants.

Preferably the base formulation comprises at least one non-ionic surfactant, at least one amphoteric surfactant and at least one anionic surfactant. Preferably the only surfactant(s) present in the base formulation are non-ionic, amphoteric and anionic surfactants.

Preferably the base formulation comprises at least one surfactant selected from esters of polyglycerol (such as the reaction product of polyglycerol and poly(ricinoleic acid) (PGPR), polyglycerol-2 polyricinoleate, polyglycerol-3 polyricinoleate), fatty acid alkanolamide compounds (such as tall oil fatty acid diethanolamide), fatty acid esters of sorbitan (such as sorbitan olivate and sorbitan oleates, especially sorbitan monooleate sold commercially under the tradename Span 80), fatty acid esters of alkoxylated sorbitan (such as fatty acid esters of ethoxylated sorbitan, for example a fatty acid ester of ethoxylated (EO20) sorbitan such as ethoxylated (EO20) sorbitan monooleate sold commercially under the tradename Tween 80 and ethoxylated (EO5) sorbitan monooleate sold commercially as Tween 81), phosphatidylcholine compounds (such as lecithin derived from soybean) and taurates (for example acyl N-alkyl taurates, such as sodium N-methyl cocoyl taurate).

The base formulation of the first aspect may comprise any suitable amount of the surfactant(s) and the particular amount may, as would be appreciated by persons skilled in the art, depend on the particular base formulation or on the particular base emulsion formulation, fracturing fluid base formulation or fracturing fluid in which the base formulation is to be used.

For example, the base formulation of the first aspect may comprise up to 40 wt %, for example up to 35 wt %, of the surfactant(s) wherein the wt % is based on the total weight of the base formulation.

For example, the base formulation of the first aspect may comprise at least 5 wt %, for example at least 10 wt %, of the surfactant(s) wherein the wt % is based on the total weight of the base formulation.

For example, the base formulation of the first aspect may comprise from 5 to 40 wt %, for example from 5 to 35 or from 10 to 35 wt %, of the surfactant(s) wherein the wt % is based on the total weight of the base formulation.

The base formulation of the first aspect may further comprise at least one polyolefin.

The or each polyolefin may be a homopolymer or a copolymer (including a random copolymer or a block-copolymer). The or each polyolefin is suitably a polymer prepared by polymerising at least one olefinic monomer. The or each polyolefin may be a homopolymer prepared by polymerising a single olefinic monomer. Alternatively, the or each polyolefin may be a copolymer prepared by polymerising at least two different olefinic monomers.

The or each olefinic monomer may be selected from α-olefins, internal olefins (for example β- or γ-olefins), conjugated dienes (for example isoprene or butadiene), styrene, substituted styrenes (for example α-methylstyrene, 4-chloromethylstyrene or divinylbenzene), acrolein, acrylonitrile, vinyl alcohol, vinyl esters (for example vinyl acetate), vinylpyrrolidone, vinylimidazole, vinylpyridine, maleic anhydride, (meth)acrylic acid, (meth)acrylic acid derivatives (for example (meth)acrylate esters and (meth)acrylamides), vinyl halides (for example vinyl chloride) and vinylidene halides (for example vinylidene fluoride).

By “(meth)acrylic” we mean “acrylic or methacrylic”. The same applies to “(meth)acrylate”, “(meth)acrylamide”, etc.

Suitably, the or each olefinic monomer is selected from the group consisting of α-olefins, internal olefins (for example β- or γ-olefins), conjugated dienes (for example isoprene or butadiene), styrene, and substituted styrenes (for example α-methylstyrene, 4-chloromethylstyrene or divinylbenzene).

Suitably, the at least one olefinic monomer comprises an olefin, preferably an α-olefin. Suitably, the at least one olefinic monomer comprises a C2 to C24 α-olefin, preferably a C6 to C18 α-olefin, for example a C8 to C14 α-olefin. The at least one olefinic monomer may comprise a mixture of olefins, preferably a mixture of α-olefins. Such mixtures may be commercially supplied. Suitably, the at least one olefinic monomer comprises a mixture of C8 to C10 α-olefins or a mixture of C12 to C14 α-olefins.

The at least one olefinic monomer preferably comprises ethylene, propylene, isoprene, styrene or a mixture thereof.

In some embodiments the polyolefin may be hydrogenated.

In some embodiments the polyolefin is a homopolymer, suitably prepared from a C6-18 α-olefin.

In some preferred embodiments the polyolefin is a block co-polymer. The block copolymer is preferably an A-B diblock copolymer or an A-B-A triblock copolymer of styrene and at least one α-olefins, for example (styrene)-(ethylene/propylene) block copolymers and (styrene)-(ethylene/propylene)-(styrene) block copolymers for example sold under the Kraton tradename.

Preferably the polyolefin(s) is a solid at room temperature and pressure.

Preferably the polyolefin(s) has a number weight molecular weight as measured by GPC of greater than 50,000 Da, preferably greater than 75,000 Da and/or of less than 1,000,000 Da, preferably less than 750,000 Da. Preferably the polyolefin(s) has a molecular weight as measured by GPC of from 90,000 to 300,000 Da.

The base formulation may comprise one (i.e. a single) polyolefin. Alternatively, the base formulation may comprise more than one, for example two or more, or three or more polyolefins. Preferably the base formulation comprises one (i.e. a single) polyolefin.

The base formulation of the first aspect may comprise any suitable amount of the polyolefin(s) and the particular amount may, as would be appreciated by persons skilled in the art, depend on the particular base formulation or on the particular base emulsion formulation, fracturing fluid base formulation or fracturing fluid in which the base formulation is to be used.

For example, the base formulation of the first aspect may comprise up to 5 wt %, for example up to 3 wt %, of the polyolefin(s) wherein the wt % is based on the total weight of the base formulation.

For example, the base formulation of the first aspect may comprise at least 0.5 wt %, for example at least 1 wt %, of the polyolefin(s) wherein the wt % is based on the total weight of the base formulation.

For example, the base formulation of the first aspect may comprise from 0.5 to 5 wt %, for example from 1 to 3 wt %, of the polyolefin(s) wherein the wt % is based on the total weight of the base formulation.

The base formulation of the first aspect may comprise:
(i) from 50 to 90 wt % of the hydrocarbon solvent(s); and
(ii) from 5 to 40 wt % of the surfactant(s);
   wherein the wt % is based on the total weight of the base formulation.

The base formulation of the first aspect may comprise:
(i) from 60 to 90 wt % of the hydrocarbon solvent(s); and
(ii) from 5 to 35 wt % of the surfactant(s);
   wherein the wt % is based on the total weight of the base formulation.

The base formulation of the first aspect may comprise:
(i) from 65 to 90 wt % of the hydrocarbon solvent(s); and
(ii) from 10 to 35 wt % of the surfactant(s);
   wherein the wt % is based on the total weight of the base formulation.

The base formulation of the first aspect may comprise:
(i) from 50 to 90 wt % of the hydrocarbon solvent(s);
(ii) from 5 to 40 wt % of the surfactant(s); and
(iii) from 0.5 to 5 wt % of the polyolefin(s);
   wherein the wt % is based on the total weight of the base formulation.

The base formulation of the first aspect may comprise:
(i) from 60 to 90 wt % of the hydrocarbon solvent(s);
(ii) from 5 to 35 wt % of the surfactant(s); and
(iii) from 1 to 3 wt % of the polyolefin(s);
   wherein the wt % is based on the total weight of the base formulation.

The base formulation of the first aspect may comprise:
(i) from 65 to 90 wt % of the hydrocarbon solvent(s);
(ii) from 10 to 35 wt % of the surfactant(s); and
(iii) from 1 to 3 wt % of the polyolefin(s);
   wherein the wt % is based on the total weight of the base formulation.

The references herein to the amounts of the hydrocarbon solvent(s), surfactant(s) and polyolefin(s) refer to the total amount of each of the particular type of components specified. For example, if the base formulation comprises two surfactants, the total of the surfactants present is for example from 5 to 40 wt %, or from 5 to 35 or from 10 to 35 wt %, wherein the wt % is based on the total weight of the base formulation. The same applies to the amounts of all components in the formulation and fracturing fluid as disclosed herein.

The base formulation of the first aspect may consist essentially of the at least one hydrocarbon solvent (i) and the at least one surfactant (ii) as defined herein.

The base formulation of the first aspect may consist essentially of the at least one hydrocarbon solvent (i), the at least one surfactant (ii) and the at least one polyolefin as defined herein.

According to a second aspect of the present invention there is provided a base emulsion formulation, for example for use in a fracturing fluid, the base emulsion formulation comprising:
(i) at least one hydrocarbon solvent;
(ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof; and
(iii) at least one aqueous fluid,
   wherein the base emulsion formulation comprises up to 50 wt % of the aqueous fluid(s) based on the total weight of the base emulsion formulation.

The base emulsion formulation of the second aspect comprises at least one aqueous fluid in an amount of up to 50 wt % wherein the wt % is based on the total weight of the base emulsion formulation. For example, the base emulsion formulation of the second aspect may comprise from 27.5 to 50 wt % of the aqueous fluid(s) wherein the wt % is based on the total weight of the base emulsion formulation.

The base emulsion formulation of the second aspect may comprise a base formulation according to the first aspect and in addition (iii) at least one aqueous fluid in an amount of up to 50 wt % based on the total weight of the base emulsion formulation.

The base emulsion formulation of the second aspect is typically an emulsion. The base emulsion formulation of the second aspect is preferably a water-in-oil emulsion. The base emulsion formulation may be used to prepare a fracturing fluid base formulation, for example by the addition of further aqueous fluid(s) thereto, such as a fracturing fluid base formulation of the third or tenth aspect.

Suitably the base emulsion formulation does not contain any proppant.

The aqueous fluid may be any fluid comprising water.

The aqueous fluid may comprise any water which comprises dissolved solids. The water may be from any source. The aqueous fluid is suitably saline and may have low or high salinity, which may be defined in terms of total dissolved solids (TDS). The aqueous fluid may have a TDS of at least 50,000 ppm, suitably at least 100,000 ppm, preferably at least 150,000 ppm, for example greater than 200,000 ppm or greater than 220,000 ppm. The TDS may be less than 500,000 pm or less than 400,000 ppm or less than 2000 ppm. The aqueous fluid may have a TDS of from 50,000 to 175,000 ppm. The aqueous fluid may comprise recovered fracturing fluid, for example flowback water. The aqueous fluid may comprise water from a subterranean source, for example an underground aquifer or a subterranean formation. The aqueous fluid may comprise fresh water into which solids, for example, at least one salts, have been added and/or fresh water which has been mixed with saline water. The aqueous fluid may be fresh water. Preferably, the aqueous fluid may comprise recovered fracturing fluid, for example flowback water, or produced water.

Preferred aqueous fluids are those having high polarity such as brines. The preferred brines are those considered produced water or flow-back water. Otherwise, the aqueous fluid can be an aqueous fluid made by adding various soluble salts such as sodium, potassium or calcium chlorides with the total dissolved solids greater than 50,000 ppm or greater than 100,000 ppm and preferably up to 250,000 ppm.

The aqueous fluid is suitably selected from potable water, surface water, brine (especially brines comprising 10 wt % NaCl), seawater, wastewater, aquifer water, produced water, flowback water, fracturing water and/or fresh water. Preferably, the aqueous fluid is selected from brine, produced water, or flowback water.

References to ppm of ions in the aqueous fluid refer to the parts-per-million (by weight) (ppm) of the specified ions relative to the total weight of the aqueous fluid.

The pH of the aqueous fluid may be less than 9.0, such as less than 6.5 or less than 6.0. It may be at least 3.5.

The base emulsion formulation of the second aspect comprises (i) at least one hydrocarbon solvent. Suitable hydrocarbon solvents are as defined in relation to the first aspect.

The base emulsion formulation may comprise at least one or more than one hydrocarbon solvent. For example, the base emulsion formulation may comprise one (i.e. a single) hydrocarbon solvent. Alternatively, the base emulsion formulation may comprise more than one, for example two or more, or three or more hydrocarbon solvents.

Preferably the base emulsion formulation comprises one (i.e. a single) hydrocarbon solvent.

The base emulsion formulation of the second aspect may comprise any suitable amount of the hydrocarbon solvent(s) and the particular amount may, as would be appreciated by persons skilled in the art, depend on the particular base emulsion formulation, or on the particular fracturing fluid base formulation or fracturing fluid in which the base emulsion formulation is to be used.

For example, the base emulsion formulation of the second aspect may comprise up to 45 wt % of the hydrocarbon solvent(s) wherein the wt % is based on the total weight of the base emulsion formulation.

For example, the base emulsion formulation of the second aspect may comprise at least 25 wt %, for example at least 30 wt %, of the hydrocarbon solvent(s) wherein the wt % is based on the total weight of the base emulsion formulation.

For example, the base emulsion formulation of the second aspect may comprise from 25 to 45 wt %, for example from 30 to 45 wt %, of the hydrocarbon solvent(s) wherein the wt % is based on the total weight of the base emulsion formulation.

The base emulsion formulation of the second aspect comprises (ii) at least one surfactant. Suitable surfactants are as defined in relation to the first aspect.

The base emulsion formulation may comprise at least one or more than one surfactant. For example, the base emulsion formulation may comprise one (i.e. a single) surfactant. Alternatively, the base emulsion formulation may comprise more than one, for example two or more, or three or more surfactants.

Preferably the base emulsion formulation comprises two or more, such as two or three, surfactants.

The base emulsion formulation of the second aspect may comprise any suitable amount of the surfactant(s) and the particular amount may, as would be appreciated by persons skilled in the art, depend on the particular base emulsion formulation, or on the particular fracturing fluid base formulation or fracturing fluid in which the base emulsion formulation is to be used.

For example, the base emulsion formulation of the second aspect may comprise up to 25 wt %, for example up to 20 wt %, of the surfactant(s) wherein the wt % is based on the total weight of the base emulsion formulation.

For example, the base emulsion formulation of the second aspect may comprise at least 4 wt %, for example at least 5 wt %, of the surfactant(s) wherein the wt % is based on the total weight of the base emulsion formulation.

For example, the base emulsion formulation of the second aspect may comprise from 4 to 25 wt %, for example from 5 to 20 wt %, of the surfactant(s) wherein the wt % is based on the total weight of the base emulsion formulation.

The base emulsion formulation of the second aspect may further comprise at least one polyolefin. Suitable polyolefins are as defined in relation to the first aspect.

The base emulsion formulation may comprise at least one or more than one polyolefin. For example, the base emulsion formulation may comprise one (i.e. a single) polyolefin. Alternatively, the base emulsion formulation may comprise more than one, for example two or more, or three or more polyolefins.

Preferably the base emulsion formulation comprises one (i.e. a single) polyolefin.

The base emulsion formulation of the second aspect may comprise any suitable amount of the polyolefin(s) and the particular amount may, as would be appreciated by persons skilled in the art, depend on the particular base emulsion formulation, or on the particular fracturing fluid base formulation or fracturing fluid in which the base emulsion formulation is to be used.

For example, the base emulsion formulation of the second aspect may comprise up to 2.5 wt %, for example up to 1.5 wt %, of the polyolefin(s) wherein the wt % is based on the total weight of the base emulsion formulation.

For example, the base emulsion formulation of the second aspect may comprise at least 0.25 wt %, for example at least 0.5 wt %, of the polyolefin(s) wherein the wt % is based on the total weight of the base emulsion formulation.

For example, the base emulsion formulation of the second aspect may comprise from 0.25 to 2.5 wt %, for example from 0.5 to 1.5 wt %, of the polyolefin(s) wherein the wt % is based on the total weight of the base emulsion formulation.

The base emulsion formulation of the second aspect may comprise:
(i) from 25 to 45 wt % of the hydrocarbon solvent(s);
(ii) from 4 to 25 wt % of the surfactant(s); and
(iii) from 27.5 to 50 wt % of the aqueous fluid(s);
   wherein the wt % is based on the total weight of the base emulsion formulation.

The base emulsion formulation of the second aspect may comprise:
(i) from 30 to 45 wt % of the hydrocarbon solvent(s);
(ii) from 5 to 20 wt % of the surfactant(s); and
(iii) from 27.5 to 50 wt % of the aqueous fluid(s);
   wherein the wt % is based on the total weight of the base emulsion formulation.

The base emulsion formulation of the second aspect may comprise:
(i) from 25 to 45 wt % of the hydrocarbon solvent(s);
(ii) from 4 to 25 wt % of the surfactant(s);
(iii) from 27.5 to 50 wt % of the aqueous fluid(s); and
(iv) from 0.25 to 2.5 wt % of the polyolefin(s);
   wherein the wt % is based on the total weight of the base emulsion formulation.

The base emulsion formulation of the second aspect may comprise:
(i) from 30 to 45 wt % of the hydrocarbon solvent(s);
(ii) from 5 to 20 wt % of the surfactant(s);
(iii) from 27.5 to 50 wt % of the aqueous fluid(s); and
(iv) from 0.5 to 1.5 wt % of the polyolefin(s);
   wherein the wt % is based on the total weight of the base emulsion formulation.

According to a third aspect of the invention, there is provided a fracturing fluid base formulation comprising:
(i) at least one hydrocarbon solvent;
(ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof; and
(iii) at least one aqueous fluid,
   wherein the fracturing fluid base formulation comprises from above 50 wt % to 99.5 wt % of the aqueous fluid(s) based on the total weight of the fracturing fluid base formulation.

The fracturing fluid base formulation of the third aspect may comprise the same components as the base emulsion formulation of the second aspect but comprises a higher amount of the aqueous fluid(s).

The fracturing fluid base formulation of the third aspect is typically an emulsion. The fracturing fluid base formulation of the third aspect is preferably a water-in-oil emulsion.

The fracturing fluid base formulation of the third aspect is preferably a shear thinning fluid.

The fracturing fluid base formulation of the third aspect may be prepared from a base formulation of the first aspect or a base emulsion formulation of the second aspect. The fracturing fluid base formulation of the third aspect may be used to prepare a fracturing fluid, such as a fracturing fluid of the fourth aspect.

Thus, the fracturing fluid base formulation of the third aspect may comprise a base formulation according to the first aspect and in addition (iii) at least one aqueous fluid in an amount of from above 50 wt % to 99.5 wt % based on the total weight of the fracturing fluid base formulation.

The fracturing fluid base formulation of the third aspect may be prepared from a base emulsion formulation of the second aspect by addition of aqueous fluid to provide an amount of from above 50 wt % to 99.5 wt % based on the total weight of the fracturing fluid base formulation.

Suitably the fracturing fluid base formulation of the third aspect does not contain any proppant. Addition of a proppant would form a fracturing fluid, such as a fracturing fluid of the fourth aspect. However, the fracturing fluid base formulation of the third aspect is able to suspend a proppant added thereto without any substantive settling of the proppant. For example, if a proppant is added to the fracturing fluid base formulation of the third aspect, the proppant may be suspended for a period of 4 hours, preferably 8 hours, at a temperature of 82.2 °C.

The fracturing fluid base formulation of the third aspect offers the advantage of being able to incorporate and transport high concentrations of proppant(s), for example ranging from 0.5 to 10 lb of proppant(s) per gallon (60 to 1,200 kg/m³) of fracturing fluid. This enables lower volumes of fracturing fluid and lower pump rates to be used.

The fracturing fluid base formulation of the third aspect may comprise a base formulation according to the first aspect and in addition (iii) at least one aqueous fluid in an amount from above 50 to 99.5 wt % wherein the wt % is based on the total weight of the fracturing fluid base formulation.

The fracturing fluid base formulation of the third aspect may comprise a base emulsion formulation according to the second aspect and additional aqueous fluid so as to provide an amount of aqueous fluid from above 50 to 99.5 wt % wherein the wt % is based on the total weight of the fracturing fluid base formulation.

The fracturing fluid base formulation of the third aspect comprises (i) at least one hydrocarbon solvent; and (ii) at least one surfactant. The fracturing fluid base formulation of the third aspect may additionally comprise at least one polyolefin. Suitable hydrocarbon solvents, surfactants and polyolefins are as defined in relation to the first aspect.

The fracturing fluid base formulation of the third aspect comprises from above 50 to 99.5 wt % of the aqueous fluid(s) wherein the wt % is based on the total weight of the fracturing fluid base formulation. Preferably, the aqueous fluid is present in the fracturing fluid base formulation in an amount of from 92 to 99.5 wt %, more preferably from 95 to 99.5 wt % wherein the wt % is based on the total weight of the fracturing fluid base formulation.

For example, the fracturing fluid base formulation of the third aspect may comprise up to 34 wt %, such as up to 15 wt % or up to 5 wt %, for example up to 3.6 wt %, of the hydrocarbon solvent(s) wherein the wt % is based on the total weight of the fracturing fluid base formulation.

For example, the fracturing fluid base formulation of the third aspect may comprise at least 0.1 wt %, for example at least 0.9 wt %, of the hydrocarbon solvent(s) wherein the wt % is based on the total weight of the fracturing fluid base formulation.

For example, the fracturing fluid base formulation of the third aspect may comprise from 0.1 to 34 wt %, such as from 0.1 to 15 wt % or from 0.1 to 5 wt %, for example from 0.9 to 3.6 wt %, of the hydrocarbon solvent(s) wherein the wt % is based on the total weight of the fracturing fluid base formulation.

For example, the fracturing fluid base formulation of the third aspect may comprise up to 16 wt %, such as up to 10 wt % or up to 5 wt %, for example up to 1.5 wt %, of the surfactant(s) wherein the wt % is based on the total weight of the fracturing fluid base formulation.

For example, the fracturing fluid base formulation of the third aspect may comprise at least 0.01 wt %, for example at least 0.3 wt %, of the surfactant(s) wherein the wt % is based on the total weight of the fracturing fluid base formulation.

For example, the fracturing fluid base formulation of the third aspect may comprise from 0.01 to 16 wt %, such as from 0.01 to 10 wt % or from 0.01 to 5 wt %, for example from 0.3 to 1.5 wt %, of the surfactant(s) wherein the wt % is based on the total weight of the fracturing fluid base formulation.

For example, the fracturing fluid base formulation of the third aspect may comprise up to 0.2 wt %, for example up to 0.15 wt %, of the polyolefin(s) wherein the wt % is based on the total weight of the fracturing fluid base formulation.

For example, the fracturing fluid base formulation of the third aspect may comprise at least 0.01 wt % of the polyolefin(s) wherein the wt % is based on the total weight of the fracturing fluid base formulation.

For example, the fracturing fluid base formulation of the third aspect may comprise from 0.01 to 0.2 wt %, for example from 0.01 to 0.15 wt %, of the polyolefin(s) wherein the wt % is based on the total weight of the fracturing fluid base formulation.

The fracturing fluid base formulation of the third aspect may comprise:
(i) from 0.1 to 5 (such as from 0.9 to 3.6) wt % of the hydrocarbon solvent(s);
(ii) from 0.01 to 5 (such as from 0.3 to 1.5) wt % of the surfactant(s); and
(iii) from above 50 to 99.5 wt % of the aqueous fluid(s);
   wherein the wt % is based on the total weight of the fracturing fluid base formulation.

The fracturing fluid base formulation of the third aspect may comprise:
(i) from 0.1 to 5 (such as from 0.9 to 3.6) wt % of the hydrocarbon solvent(s);
(ii) from 0.01 to 5 (such as from 0.3 to 1.5) wt % of the surfactant(s);
(iii) from above 50 to 99.5 wt % of at least one aqueous fluid and
(iv) from 0 to 0.2 (such as from 0.01 to 0.15) wt % of the polyolefin(s);
   wherein the wt % is based on the total weight of the fracturing fluid base formulation.

Suitable aqueous fluids are as defined in relation to the second aspect.

The base emulsion formulation according to the second aspect and the fracturing fluid base formulation according to the third aspect may each be referred to as a high internal phase emulsion.

Preferably, the fracturing fluid base formulation may comprise at least one demulsifier. The fracturing fluid base formulation may comprise from 100 to 2,000 ppm, preferably from 250 to 1,500 ppm, more preferably from 500 to 1,000 ppm based on the fracturing fluid base formulation. The skilled person would appreciate that the suitable amount of demulsifier may be selected based on the stage at which the eventual fracturing fluid is required to break from the emulsion.

When the fracturing fluid base formulation of the third aspect is an emulsion, the demulsifier may be desirable to accelerate degradation of the emulsion, which may assist fluid recovery and/or well clean-up after a fracturing treatment. However, a demulsifier may not be necessary if the emulsion can itself degrade with increased temperature, especially at (or about) the temperature of a wellbore.

Preferred demulsifiers are those that are inactive within the fracturing fluid base formulation at room temperature but active at the elevated temperature found within a wellbore, for example active at temperatures above 65 °C. Examples of suitable demulsifiers include alkoxylated phenol resins (for example ethoxylated phenolic resins such as Witbreak GBG 3172), alkoxylated alkylphenol resins (for example nonylphenol-formaldehyde resins reacted with ethylene oxide, such as Witbreak DRC-163), and 4-(1,1-dimethylpropyl)phenol-formaldehyde resins reacted with a mixture of propylene oxide and ethylene oxide (for example INC 2345) According to a fourth aspect of the invention, there is provided a fracturing fluid comprising the fracturing fluid base formulation according to the third aspect and further comprising at least one proppant.

Any suitable proppant(s) may be included in the fracturing fluid. Suitable proppants would be known to persons skilled in the art.

Suitable proppants may have a size of at least 140 US mesh; and it may have a size of less than 5 US mesh. The proppant may be selected from sand, bauxite (preferably sintered bauxite), man-made intermediate or high strength materials (such as intermediate strength ceramic), and low density proppants such as nylon, styrene butadiene or walnut shell. A preferred proppant is 100 mesh sand. Another preferred proppant is 40/70 mesh sand. The proppant may be coated with a suitable resin such as a phenol or furan resin. The proppant is arranged to restrict close down of a fracture on removal of hydraulic pressure which caused the fracture.

The fracturing fluid may comprise at least 2 wt %, for example at least 5 wt % or at least 10 wt % of proppant(s). The fracturing fluid may comprise up to 55 wt % of proppant(s).

The fracturing fluid may comprise from 2 to 50 wt %, for example from 5 to 50 wt % or from 10 to 50 wt % of proppant(s).

The fracturing fluid may further comprise at least one additional component, such as at least one additive often or generally used in fracturing fluid. Examples of such additives include friction reducers (e.g. water soluble polymers, especially polyacrylamides or copolymers of acrylamide with acrylic acid and/or 2-acrylamido-2-methylpropane sulfonic acid (AMPS) and salts of these, which water-soluble polymers suitably have a molecular weight of 1 million to 20 million Daltons), proppants, acids, fluid loss control additives, gelling agents, pH adjustment additives, buffers, cross-linkers, oxidizing agents, enzymes, gel degrading agents, foamers, biocides, flow-back additives, iron control agents, clay control additives, paraffin inhibitors, corrosion inhibitors, cross-linking delay additives, scale inhibitors, demulsifiers, and/or thermal stabilisers. Such additives may be incorporated into the fracturing fluid at their usual concentrations, for example in the range 0.25 to 10 gallons per 1000 gallons (0.95 to 37.8 litres per 3,785.4 litres) of fracturing fluid.

Preferably, the fracturing fluid may comprise at least one scale inhibitor. The fracturing fluid may comprise at least 0.01 wt %, preferably at least 0.03 wt %, more preferably at least 0.05 wt %, and/or up to 2 wt % of scale inhibitor(s). The scale inhibitors may be phosphonate-based or acrylate-based.

Preferably, the fracturing fluid may comprise at least one demulsifier. Examples of suitable demulsifiers are as defined in relation to the third aspect.

In the fracturing fluid of the fourth aspect the proppant may be suspended therein without any substantive settling of the proppant. For example, the fracturing fluid can suspend the proppant for a period of 4 hours, preferably 8 hours, at a temperature of 82.2 °C, wherein 5 ppga (600 kg/m³ or 35.9 wt %) of proppant was added (i.e. wherein 600 kg of proppant was added to 1 m³ of fracturing fluid.

Thus, the fracturing fluid of the fourth aspect is able to incorporate and transport high concentrations of proppant(s), for example ranging from 0.5 to 10 lb (60 to 1200 kg/m³) of proppant(s) per gallon of fracturing fluid. This enables lower volumes of fracturing fluid and lower pump rates to be used. The fracturing fluid is also able to treat longer stage intervals, and may result in the use of fewer plugs, and so less plug removal. The fracturing fluid also may negate the need for near-well diversion and/or the lower volumes and pump rates may reduce frac hits, which in turn allows tighter in-fill drilling.

According to a fifth aspect of the present invention there is provided a method of preparing a base formulation according to the first aspect, the method comprising:
(a) selecting and admixing the hydrocarbon solvent(s) (i) and the surfactant(s) (ii).

The method of the fifth aspect may further comprise selecting and admixing at least one polyolefin with the hydrocarbon solvent(s) (i) and the surfactant(s) (ii).

The mixing may be conducted using any suitable mixer, as would be well known to persons skilled in the art.

Suitable hydrocarbon solvents, surfactants and polyolefins for use in the method of the fifth aspect are as defined in relation to the first aspect.

According to a sixth aspect of the present invention there is provided a method of preparing a base emulsion formulation according to the second aspect, the method comprising:
(a) selecting and admixing the hydrocarbon solvent(s) (i), the surfactant(s) (ii) and the aqueous fluid(s) (iii).

In step (a) of the method of the sixth aspect, the hydrocarbon solvent(s), the surfactant(s) and the aqueous fluid(s) are mixed so as to provide the base emulsion formulation in which the total amount of the aqueous fluid(s) present is up to 50 wt % based on the total weight of the base emulsion formulation.

For example, step (a) of the method of the sixth aspect may comprise:
(a1) selecting and admixing the hydrocarbon solvent(s) and the surfactant(s) to provide a base formulation; and
(a2) admixing the base formulation with the aqueous fluid(s).

In step (a2) of the method, the base formulation and the aqueous fluid(s) (iii) are mixed so as to provide the base emulsion formulation in which the total amount of the aqueous fluid(s) present is up to 50 wt % based on the total weight of the base emulsion formulation.

In the method of the sixth aspect, the aqueous fluid(s) may be added to the hydrocarbon solvent(s) and the surfactant(s), or to the base formulation, in portions to provide the base emulsion formulation in which the total amount of the aqueous fluid(s) present is up to 50 wt % based on the total weight of the base emulsion formulation.

Step (a) of the method of the sixth aspect may further comprise selecting and admixing at least one polyolefin with the hydrocarbon solvent(s) (i), the surfactant(s) and the aqueous fluid(s) to provide the base formulation. For example, the polyolefin(s) may be admixing with the hydrocarbon solvent(s) and the surfactant(s) in step (a1) to provide a base formulation, which is then admixed with the aqueous fluid(s).

The mixing may be conducted using any suitable mixer, as would be well known to persons skilled in the art. For example, the mixing may be conducted using any suitable industrial equipment for making an emulsion, such as a static mixer. Suitably multiple static mixers connected in line may be used.

Suitable hydrocarbon solvents, surfactants and polyolefins for use in the method of the sixth aspect are as defined in relation to the first aspect. Suitable aqueous fluids for use in the method of the sixth aspect are as defined in relation to the second aspect.

Step (a1) of the method of the sixth aspect may correspond to the method of the fifth aspect.

The base emulsion formulation prepared according to the sixth aspect may for example be used in a fracturing fluid base formulation or in a fracturing fluid.

The method of the sixth aspect typically provides an emulsion. The method of the sixth aspect may provide a water-in-oil emulsion.

The method of the sixth aspect may further comprise selecting and admixing at least one polyolefin with the hydrocarbon solvent(s) (i), the surfactant(s) (ii) and the aqueous fluid(s) (iii).

According to a seventh aspect of the present invention there is provided a method of preparing a fracturing fluid base formulation according to the third aspect, the method comprising:
(a) selecting and admixing the hydrocarbon solvent(s) (i), the surfactant(s) (ii) and the aqueous fluid(s) (iii).

In step (a) of the method of the seventh aspect, the hydrocarbon solvent(s) (i), the surfactant(s) (ii) and the aqueous fluid(s) (iii) are mixed so as to provide the fracturing fluid base formulation in which the total amount of the aqueous fluid(s) present is from above 50 wt % to 99.5 wt % based on the total weight of the fracturing fluid base formulation.

For example, step (a) of the method of the seventh aspect may comprise:
(a1) selecting and admixing the hydrocarbon solvent(s) and the surfactant(s) to provide a base formulation;
(a2) admixing the base formulation with at least one aqueous fluid to provide a base emulsion formulation in which the total amount of the aqueous fluid(s) present is up to 50 wt % based on the total weight of the base emulsion formulation; and
(a3) admixing the base emulsion formulation with at least one aqueous fluid.

Step (a1) of the method of the seventh aspect may correspond to the method of the fifth aspect.

Step (a2) of the method of the seventh aspect may comprise admixing the first volume of the base formulation with a volume of the aqueous fluid(s) that is equal to the first volume to provide a base emulsion formulation, i.e. in which the total amount of the aqueous fluid(s) present is 50 wt % based on the total weight of the base emulsion formulation

In step (a3) of the method, the base emulsion formulation and the aqueous fluid(s) are mixed so as to provide the fracturing fluid base formulation in which the total amount of the aqueous fluid(s) present is from above 50 wt % to 99.5 wt % based on the total weight of the fracturing fluid base formulation.

Suitably, step (a3) provides a fracturing fluid base formulation in which the total amount of the aqueous fluid(s) present is from 92 to 99.5 wt %, preferably from 95 to 99.5 wt %, wherein the wt % is based on the total weight of the fracturing fluid base formulation.

In the method of the seventh aspect, the aqueous fluid(s) may be added to the hydrocarbon solvent(s) and the surfactant(s), or to the base formulation, or to the base emulsion formulation, in portions to provide the fracturing fluid base formulation in which the total amount of the aqueous fluid(s) present is from above 50 wt % to 99.5 wt % based on the total weight of the fracturing fluid base formulation.

The method of the seventh aspect may comprise:
(a1) selecting and admixing the hydrocarbon solvent(s) and the surfactant(s) to provide a base formulation of a first volume;
(a2) admixing the first volume of the base formulation with a volume of the aqueous fluid(s) that is equal to the first volume to provide a base emulsion formulation;
(b) admixing the base emulsion formulation with at least one aqueous fluid in an amount that doubles the volume of the mixture so formed; and
(c) repeating step (b) until the total amount of the aqueous fluid(s) present in the fracturing fluid base formulation is from above 50 to 99.5 wt % based on the total weight of the fracturing fluid base formulation.

Suitable hydrocarbon solvents, surfactants and polyolefins for use in the method of the seventh aspect are as defined in relation to the first aspect. Suitable aqueous fluids for use in the method of the seventh aspect are as defined in relation to the second aspect.

The method of the seventh aspect typically provides an emulsion. The method of the seventh aspect may provide a water-in-oil emulsion.

Steps (a2), (b) and (c) as described in relation to the method of the seventh aspect may each provide a water-in-oil emulsion.

Suitably, step (c) may be repeated until the aqueous fluid is present in an amount of from 92 to 99.5 wt %, preferably from 95 to 99.5 wt %, wherein the wt % is based on the total weight of the fracturing fluid base formulation.

The method of the seventh aspect may further comprise selecting and admixing at least one polyolefin with the hydrocarbon solvent(s) (i), the surfactant(s) (ii) and the aqueous fluid(s) (iii).

According to an eighth aspect of the present invention there is provided a base formulation made by the method of the fifth aspect.

According to a ninth aspect of the present invention there is provided a base emulsion formulation made by the method of the sixth aspect.

According to a tenth aspect of the present invention there is provided a fracturing fluid base formulation made by the method of the seventh aspect.

According to an eleventh aspect of the present invention there is provided a method of preparing a fracturing fluid according to the fourth aspect, the method comprising admixing the fracturing fluid base formulation according to the third or tenth aspect with at least one proppant. The proppant may be suitably added to the base fracturing fluid or during the preparation of the base fracturing fluid. The proppant may be added in any suitable manner known to those skilled in the art, for example using static mixers or dry blending units typically used to add proppant to conventional fracturing fluids.

According to a twelfth aspect of the present invention there is provided a fracturing fluid made by the method of the eleventh aspect.

According to a thirteenth aspect of the present invention there is provided a method of fracturing a subterranean formation, the method comprising contacting the formation with a fracturing fluid according to the fourth or twelfth aspect.

According to a fourteenth aspect of the present invention there is provided an assembly positioned adjacent a subterranean formation and arranged to deliver a fracturing fluid into the formation, said assembly comprising:
(I) a receptacle containing at least one aqueous fluid;
(II) a receptacle containing a base formulation according to the first or eighth aspect or a base emulsion formulation according to the second or ninth aspect;
(III) a receptacle containing at least one additive, for example at least one proppant;
(IV) at least one pump (PI) for dosing the base formulation or the base emulsion formulation from the receptacle (II) and the at least one additive from the receptacle (III) into the at least one aqueous fluid, suitably to provide at least part of a fracturing fluid;
(V) a conduit for delivering the fracturing fluid into the formation; and
(VI) a pump (P2) for injecting the fracturing fluid via the conduit into the formation.

In the assembly of the fourteenth aspect the receptacle in step (II) preferably contains a base emulsion formulation according to the second or ninth aspect.

The assembly of the fourteenth aspect is preferably positioned adjacent a well containing a conduit from the surface to the subterranean formation.

Suitable aqueous fluids in the assembly of the fourteenth aspect are as defined in relation to the second aspect.

According to a fifteenth aspect of the present invention, there is provided a use of a fracturing fluid according to the fourth or twelfth aspect for fracturing a subterranean formation.

### BRIEF DESCRIPTION OF DRAWINGS

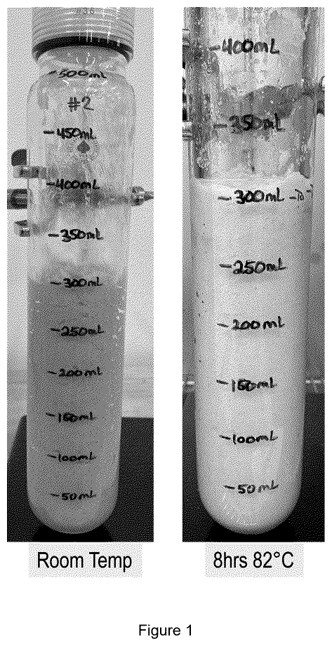

For a better understanding of the invention, and to show how exemplary embodiments of the same may be carried into effect, reference will be made, by way of example only, to the accompanying diagrammatic FIGURES, in which FIG. 1 shows the results of a sand (proppant) suspension test as set out in Example 4.

The invention will now be further described with reference to the following non-limiting examples.

### EXAMPLES

### Example 1 Preparation of Base Formulations

Base formulations A, B, C and D were prepared by admixing the components set out in table 1.

TABLE 1

| | Composition | Composition | Composition | Composition |
|---|---|---|---|---|
| | A (wt % | B (wt % | C (wt % | D (wt % |
| Component | active) | active) | active) | active) |
| Polyglycerol-3 | 3.17 | | | 3.17 |
| Polyricinoleate | | | | |
| Tall oil fatty acid | 27.56 | 7.84 | | |
| diethanolamide | | | | |
| Span 80 sorbitan | | 1.23 | | |
| monooleate) | | | | |
| Tween 81 | | 1.72 | 20.51 | |
| ethoxylated | | | | |
| (EO5) sorbitan | | | | |
| monooleate | | | | |
| Soy Bean Lecithin | | | 10.49 | |
| Sodium Cocoyl N- | | | | 27.56 |
| methyl taurate* | | | | |
| polystyrene- | 2.20 | | | 2.20 |
| Ethylene/Propylene- | | | | |
| polystyrene block | | | | |
| copolymer** | | | | |
| Hydrotreated Naphtha | 67.07 | 89.21 | 69.00 | 67.07 |

*added as a low NaCl, solid powder with 95% active taurate
**commercially available as Kraton MD8705

### Example 2—Preparation of Base Emulsion Formulations

90 g of each of the base formulations A, B and C shown in Table 1 were mixed with an equal weight of 10 wt % aqueous NaCl solution (brine) in a 200 ml glass jar. The lid was then screwed onto the jar to seal the contents, and the jar shaken vigorously for several minutes until the two phases disappeared and formed a white emulsion, i.e. to prepare base emulsion formulations A, B and C.

The same method was conducted using base formulation D except that 8 g of base formulation and 8 g of aqueous NaCl solution (brine) was used to prepare the base emulsion formulation D.

### Example 3—Preparation of Fracturing Fluid Base Formulations

60 g of each of the base emulsion formulations A, B and C prepared in Example 2 was added to a 1 litre beaker equipped with an overhead stirrer containing a 3.8 cm diameter propeller mixing head. The stirrer speed was 500 rpm and 60 g of 10 wt % aqueous NaCl solution (brine) was slowly added to the base emulsion formulation and blended until homogeneous. This process was repeated, each time adding enough 10 wt % aqueous NaCl solution (brine) to double the volume of the mixture so formed. In the final step, a final portion of 10 wt % aqueous NaCl solution (brine) was incorporated to give a content of aqueous phase between 96 to 99 wt %, i.e. to prepare fracturing fluid base formulations A, B and C (in the form of emulsions).

The amount of 10 wt % aqueous NaCl solution (brine) added to base emulsion formulation A, B or C over the course of Example 3 is summarised in Table 2.

TABLE 2

| Fluid Addition | | Brine | Final Total |
|---|---|---|---|
| Step | Fluid | Addition (g) | Weight (g) |
| 1 | 60 g base emulsion | 60 | 120 |
| | formulation A | | |
| 2 | 120 g Emulsion | 120 | 240 |
| 3 | 240 g Emulsion | 240 | 480 |
| 4 | 480 g Emulsion | 480 | 960 |
| 5 | 960 g Emulsion | 960 | 1920 |
| 6 | 1920 g Emulsion | 80 | 2000 |

The method as set out using base emulsion formulations A, B and C was repeated using base emulsion formulation D prepared in Example 2 but instead starting from 16 g of base emulsion formulation D prepared in Example 2.

The fracturing fluid base formulations prepared are as shown in Table 3:

TABLE 3

| | Composition | Composition | Composition | Composition |
|---|---|---|---|---|
| | A (wt % | B (wt % | C (wt % | D (wt % |
| Component | active) | active) | active) | active) |
| Brine | 98.63 | 96.00 | 96.00 | 95.56 |
| Polyglycerol-3 | 0.04 | 0.00 | 0.00 | 0.14 |
| Polyricinoleate | | | | |
| Tall oil fatty acid | 0.38 | 0.31 | 0.00 | 0.00 |
| diethanolamide | | | | |
| Span 80 | 0.00 | 0.05 | 0.00 | 0.00 |
| Tween 81 | 0.00 | 0.07 | 0.82 | 0.00 |
| Soy Lecithin | 0.00 | 0.00 | 0.42 | 0.00 |
| Sodium Cocoyl | 0.00 | 0.00 | 0.00 | 1.22 |
| N-methyl | | | | |
| Taurate* | | | | |
| polystyrene- | 0.03 | 0.00 | 0.00 | 0.10 |
| Ethylene/Propylene- | | | | |
| polystyrene block | | | | |
| copolymer** | | | | |
| Hydrotreated | 0.92 | 3.57 | 2.76 | 2.98 |
| Naphtha | | | | |

*added as a low NaCl, solid powder with 95% active taurate
**commercially available as Kraton MD8705

Table 4 shows the results of Example 3 starting from each of base emulsion formulations A, B, C and D.

TABLE 4

| Fracturing fluid | Total aqueous | |
|---|---|---|
| base formulation | phase (wt %) | Emulsion rating |
| A | 98.63 | Pass - incorporated all water |
| | | stages and stable for 48 hours |
| | | at 65.5 °C |
| B | 96.00 | Pass - incorporated all water |
| | | stages and stable for 48 hours |
| | | at 65.5 °C |
| C | 96.00 | Pass - incorporated all water |
| | | stages and stable for 48 hours |
| | | at 65.5 °C |
| D | 95.65 | Pass |

### Example 4—Sand (Proppant) Suspension Test

Example 3 was repeated using fracturing fluid base formulation A with the exception that immediately after the brine addition at fluid addition step 5 1200 g of 40/70 mesh sand was added to the formulation and then the final addition of brine was carried out. After the last addition of brine, the formulation was transferred to a 500 ml glass, sealable tube with graduated volume markings. One tube was left at ambient temperature, and the other was placed upright in an oven set for 82.2 °C. After 8 hours at 82.2 °C, there was no settling of the sand as shown in FIG. 1. The 8 hour time is about 3 times longer than most fracturing treatments.

This shows that the fracturing fluid base formulation has exceptional sand carrying capacity, and provides a stable fracturing fluid, as needed for hydraulic fracturing treatment.

### Example 5—Emulsion Breaking

Several different demulsifiers were added to the base emulsion formulation A of example 2 and the fracturing fluid base formulation was then formed according to the method of example 3. The formulations were stable at room temperature. They were then heated to 71 °C and the time that they took to break was recorded and is shown in Table 5.

TABLE 5

| | | | Break |
|---|---|---|---|
| | De-emulsifier | Concentration | time (hours) |
| De-emulsifier | Type | (ppm)* | at 71 °C |
| Witbreak DRC-163 | formaldehyde resin of 4- | 1000 | 2.50 |
| | nonylphenol and oxirane | | |
| Witbreak GBG 3172 | Oxyalkylated phenolic resin | 1000 | 2.00 |
| INC 2345 | Formaldehyde resin of 4- | 1000 | 1.25 |
| | (1,1-dimethylpropyl)phenol, | | |
| | 2-methyloxirane and oxirane | | |
| INC 2345 | Formaldehyde resin of 4- | 500 | 3.50 |
| | (1,1-dimethylpropyl)phenol, | | |
| | 2-methyloxirane and oxirane | | |

*ppm by weight of the fracturing fluid base formulation

The present invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A base formulation, for example for use in a fracturing fluid, the base formulation comprising:
(i) at least one hydrocarbon solvent; and
(ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof.

2. The base formulation according to claim 1, wherein the base formulation further comprises at least one polyolefin.

3. The base formulation according to claim 2, wherein the base formulation comprises:
(i) from 50 to 90 wt % of the hydrocarbon solvent(s);
(ii) from 5 to 40 wt % of the surfactant(s); and
(iii) from 0.5 to 5 wt % of the polyolefin(s);
wherein the wt % is based on the total weight of the base formulation.

4. A base emulsion formulation, for example for use in a fracturing fluid, the base emulsion formulation comprising:
(i) at least one hydrocarbon solvent;
(ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof; and
(iii) at least one aqueous fluid,
wherein the base emulsion formulation comprises up to 50 wt % of the aqueous fluid(s) based on the total weight of the base emulsion formulation.

5. The base emulsion formulation according to claim 4, wherein the base emulsion formulation further comprises at least one polyolefin.

6. The base emulsion formulation according to claim 5, wherein the base emulsion formulation comprises:
(i) from 25 to 45 wt % of the hydrocarbon solvent(s);
(ii) from 7 to 25 wt % of the surfactant(s);
(iii) from 27.5 to 50 wt % of the aqueous fluid(s); and
(iv) from 0.25 to 2.5 wt % of the polyolefin(s);
wherein the wt % is based on the total weight of the base emulsion formulation.

7. A fracturing fluid base formulation comprising:
(i) at least one hydrocarbon solvent;
(ii) at least one surfactant selected from a non-ionic surfactant, an amphoteric surfactant, an anionic surfactant and a cationic surfactant, and combinations thereof,
wherein when the formulation comprises a non-ionic surfactant, the non-ionic surfactant is selected from a fatty alcohol, a fatty alcohol alkoxylate, a fatty acid amide alkoxylate, a hydroxy fatty acid amide alkoxylate, a hydroxy fatty acid alkoxylate, a triglyceride alkoxylate, a tristyryl phenol alkoxylate, a fatty acid ester of alkoxylated sorbitan, a polyalkylene alkoxylate, a glycerol alkoxylate, a fatty acid alkoxylate, an alkoxylated alkyl phenol, a polyalkylene glycol ether, a polyalkoxylated tallow amine; a fatty acid alkanolamide, a fatty acid ester of sorbitan, a fatty acid ester, a sugar ester, an alkyl polyglucoside and an ester of polyglycerol, and combinations thereof; and
(iii) at least one aqueous fluid,
wherein the fracturing fluid base formulation comprises from above 50 wt % to 99.5 wt % of the aqueous fluid(s) based on the total weight of the fracturing fluid base formulation.

8. The fracturing fluid base formulation according to claim 7, wherein the fracturing fluid base formulation further comprises at least one polyolefin.

9. The fracturing fluid base formulation according to claim 7, wherein the fracturing fluid base formulation comprises from 92 to 99.5 wt %, preferably from 95 to 99.5 wt %, of the aqueous fluid(s) based on the total weight of the fracturing fluid base formulation.

10. The base emulsion formulation or a fracturing fluid base formulation according to claim 4, wherein the base emulsion formulation or the fracturing fluid base formulation is a water-in-oil emulsion.

11. The base formulation according to claim 1, wherein the or each surfactant is selected from at least one non-ionic surfactant, at least one amphoteric surfactant and at least one anionic surfactant.

12. The base formulation according to claim 1, wherein the or each surfactant is selected from at least one non-ionic surfactant and at least one amphoteric surfactant.

13. The base formulation according to claim 1, wherein the one or more surfactants (ii) comprise at least one non-ionic surfactant, preferably wherein the or each non-ionic surfactant has a hydrophobic-lipophilic balance (HLB) value of from 7 to 10.

14. The base formulation according to claim 13, wherein the or each non-ionic surfactant is selected from an ester of polyglycerol, a fatty acid alkanolamide compound, a fatty acid ester of sorbitan and a fatty acid ester of alkoxylated sorbitan, and combinations thereof.

15. The base formulation according to claim 1, wherein the or each surfactant is selected from an ester of polyglycerol, a fatty acid alkanolamide compound, a fatty acid ester of sorbitan, a fatty acid ester of alkoxylated sorbitan, a phosphatidylcholine compound and a taurate, and combinations thereof, preferably selected from an ester of polyglycerol, a fatty acid ester of sorbitan, a fatty acid ester of alkoxylated sorbitan, a phosphatidylcholine compound and a taurate, and combinations thereof.

16. The base formulation according to claim 1, wherein the or each hydrocarbon solvent is selected from at least one of paraffinic hydrocarbons, naphthenic hydrocarbons, aromatic hydrocarbons, benzene, xylene, toluene, mineral oils, diesel oil, kerosenes, naphthas (including hydrotreated naphtha), petrolatums, branch-chain isoparaffinic solvents, branch-chain hydrocarbons, saturated, linear, and/or branched paraffin hydrocarbons.

17. The base formulation according to claim 2, wherein the or each polyolefin is selected from α-olefins, internal olefins (for example β- or γ-olefins), conjugated dienes (for example isoprene or butadiene), styrene, substituted styrenes (for example α-methylstyrene, 4-chloromethylstyrene or divinylbenzene), acrolein, acrylonitrile, vinyl alcohol, vinyl esters (for example vinyl acetate), vinylpyrrolidone, vinylimidazole, vinylpyridine, maleic anhydride, (meth)acrylic acid, (meth)acrylic acid derivatives (for example (meth)acrylate esters and (meth)acrylamides), vinyl halides (for example vinyl chloride) and vinylidene halides (for example vinylidene fluoride).

18. The base formulation according to claim 2, wherein the or each polyolefin is a block co-polymer, for example a (styrene)-(ethylene/propylene) block copolymer and/or a (styrene)-(ethylene/propylene)-(styrene) block copolymer.

19. A fracturing fluid comprising the fracturing fluid base formulation according to claim 7 and further comprising at least one proppant.

20. A method of preparing a base formulation according to claim 1, the method comprising:
(a) selecting and admixing the hydrocarbon solvent(s) (i) and the surfactant(s) (ii).

21. A method of preparing a base emulsion formulation according to claim 4, the method comprising:
(a) selecting and admixing the hydrocarbon solvent(s) (i), the surfactant(s) (ii) and the aqueous fluid(s) (iii).

22. The method according to claim 21, wherein step (a) of the method comprises:
(a1) selecting and admixing the hydrocarbon solvent(s) and the surfactant(s) to provide a base formulation; and
(a2) admixing the base formulation with the aqueous fluid(s).

23. The method according to claim 22, wherein step (a2) provides a water-in-oil emulsion.

24. A method of preparing a fracturing fluid base formulation according to claim 7, the method comprising:
(a) selecting and admixing the hydrocarbon solvent(s) (i), the surfactant(s) (ii) and the aqueous fluid(s) (iii).

25. The method according to claim 24, wherein step (a) of the method comprises:
(a1) selecting and admixing the hydrocarbon solvent(s) and the surfactant(s) to provide a base formulation;
(a2) admixing the base formulation with at least one aqueous fluid to provide a base emulsion formulation in which the total amount of the aqueous fluid(s) present is up to 50 wt % based on the total weight of the base emulsion formulation; and
(a3) admixing the base emulsion formulation with at least one aqueous fluid.

26. The method according to claim 25, wherein step (a2) of the method comprises admixing the first volume of the base formulation with a volume of the aqueous fluid(s) that is equal to the first volume to provide a base emulsion formulation in which the total amount of the aqueous fluid(s) present is 50 wt % based on the total weight of the base emulsion formulation

27. The method according to claim 25, wherein step (a3) provides a fracturing fluid base formulation in which the total amount of the aqueous fluid(s) present is from 92 to 99.5 wt %, preferably from 95 to 99.5 wt %, wherein the wt % is based on the total weight of the fracturing fluid base formulation.

28. The method according to claim 25, wherein steps (a2) and (a3) provide a water-in-oil emulsion.

29. A base formulation made by the method of claim 20.

30. A base emulsion formulation made by the method of claim 21.

31. A fracturing fluid base formulation made by the method of claim 24.

32. A method of preparing a fracturing fluid according to claim 19, the method comprising admixing the fracturing fluid base formulation according to claim 7 with at least one proppant.

33. A fracturing fluid made by the method of claim 32.

34. A method of fracturing a subterranean formation, the method comprising contacting the formation with a fracturing fluid according to claim 19.

35. An assembly positioned adjacent a subterranean formation and arranged to deliver a fracturing fluid into the formation, said assembly comprising:
(I) a receptacle containing at least one aqueous fluid;
(II) a receptacle containing a base formulation according to claim 1 or a base emulsion formulation according to claim 4;
(III) a receptacle containing at least one additive, for example at least one proppant;
(IV) at least one pump (PI) for dosing the base formulation or base emulsion formulation from the receptacle (II) and the at least one additive from the receptacle (III) into the at least one aqueous fluid, suitably to provide at least part of a fracturing fluid;
(V) a conduit for delivering the fracturing fluid into the formation; and
(VI) a pump (P2) for injecting the fracturing fluid via the conduit into the formation.
